(19) United States
(12) Patent Application Publication
(10) Pub. No.: US 2023/0200470 A1
(43) Pub. Date: Jun. 29, 2023

(54) A PERSONAL PROTECTIVE EQUIPMENT

(71) Applicants: Daniel POISSANT, Mont-Saint-Hilaire (CA); Samuel POISSANT, La Presentation (CA)

(72) Inventors: Daniel POISSANT, Mont-Saint-Hilaire (CA); Samuel POISSANT, La Presentation (CA)

(21) Appl. No.: 17/999,681

(22) PCT Filed: Apr. 13, 2021
(86) PCT No.: PCT/CA2021/050493

§ 371 Date: Nov. 22, 2022

Related U.S. Application Data
(60) Provisional application No. 63/034,149, filed on Jun. 3, 2020.

(51) Int. Cl. A41D 13/11; A62B 18/02

(52) U.S. Cl. CPC A41D 13/1184; A62B 18/025; A62B 23/02

(57) ABSTRACT

A wearable personal protection comprising a mask configured to be air-tightly secured in contact with the face of a wearer and a face shield configured to be air-tightly connected to a passageway of the mask. The face shield has a front surface having a flared geometry from a bottom edge thereof up to a top edge thereof and backwardly curved lateral sides, with a bottom surface extending at an angle from the front surface, so that the face shield provides a mechanical barrier against aerial bacteria between the environment and the face of the wearer from under the chin as well as from both lateral sides of the wearer's face well up over the nose.

### FIELD OF THE INVENTION

The present invention relates to a personal protective equipment.

### BACKGROUND OF THE INVENTION

Personal protective equipment range from gowns and gloves to masks, eye and facial protections. Facial protections such as masks, face shields or masks with visor attachments and respirators for example, are used to provide a barrier against potential exposure to diseases or particles.

Autoclave sterilization may be required depending on applications each piece of protective equipment. Autoclave sterilization is a lengthy process, typically requiring between about 40 and about 60 minutes in small-capacity autoclaves for surgical equipment, laboratory instruments, pharmaceutical items in heath in hospitals or health laboratories.

Facial protections such as masks may be submitted to regulations and pass conformity tests such as portacount respirator fit tests, certified by regulation authorities, such as the Occupational Safety and Health Administration (OSHA) or the American National Standards Institute (ANSI) in the United States for example.

There is still a need in the art for a personal protective equipment.

### BRIEF DESCRIPTION OF THE DRAWINGS

In the appended drawings:

FIG. 1 is a perspective front view of a unit according to an embodiment of an aspect of the present disclosure;

FIG. 2 is a side exploded view of the unit of FIG. 1;

FIG. 3 is a side view of a unit as worn by a wearer according to an embodiment of an aspect of the present disclosure;

FIG. 4 is a side view of a unit as worn by a wearer according to an embodiment of an aspect of the present disclosure;

FIG. 5 is a side view of a unit as worn by a wearer according to an embodiment of an aspect of the present disclosure;

FIG. 6 is a front view of a unit as worn by a wearer according to an embodiment of an aspect of the present disclosure;

FIG. 7 is a perspective bottom view of a unit as worn by a wearer according to an embodiment of a unit of the present disclosure; and

FIG. 8 is a view of a unit according to an embodiment of a unit of the present disclosure;

FIG. 9 shows a cut sheet for a face shield according to an embodiment of a unit of the present disclosure; and

FIG. 10 is an exploded view of a unit according to an embodiment of a unit of the present disclosure.

### SUMMARY OF THE INVENTION [Lavery Completera Ici]*

More specifically, in accordance with the present invention, there is provided a wearable personal protection comprising a mask configured to be air-tightly secured in contact with the face of a wearer and a face shield configured to be air-tightly connected to a passageway of a front surface of the mask.

There is further provided a wearable personal protection comprising a mask configured to be air-tightly secured in contact with the face of a wearer and a face shield configured to be air-tightly connected to a passageway of a front surface of the mask, a front surface of the face shield having a flared geometry from a bottom edge thereof up to a top edge thereof and backwardly curved lateral sides, and a bottom surface of the face shield extending at an angle from the front surface.

There is further provided a wearable personal protection comprising a mask configured to be air-tightly secured in contact with the face of a wearer, a face shield and a cartridge configured to be air-tightly connected to a passageway of the mask, the face shield comprising a bottom surface extending backwardly from a front surface of a flared geometry and having backwardly curved lateral sides.

Other objects, advantages and features of the present invention will become more apparent upon reading of the following non-restrictive description of specific embodiments thereof, given by way of example only with reference to the accompanying drawings.

The present invention is illustrated in further details by the following non-limiting examples.

### DESCRIPTION OF EMBODIMENTS OF THE INVENTION

A unit 10 according to an embodiment of an aspect of the present disclosure comprises a mask 30 and a face shield 40 configured to be worn by a wearer as a wearable.

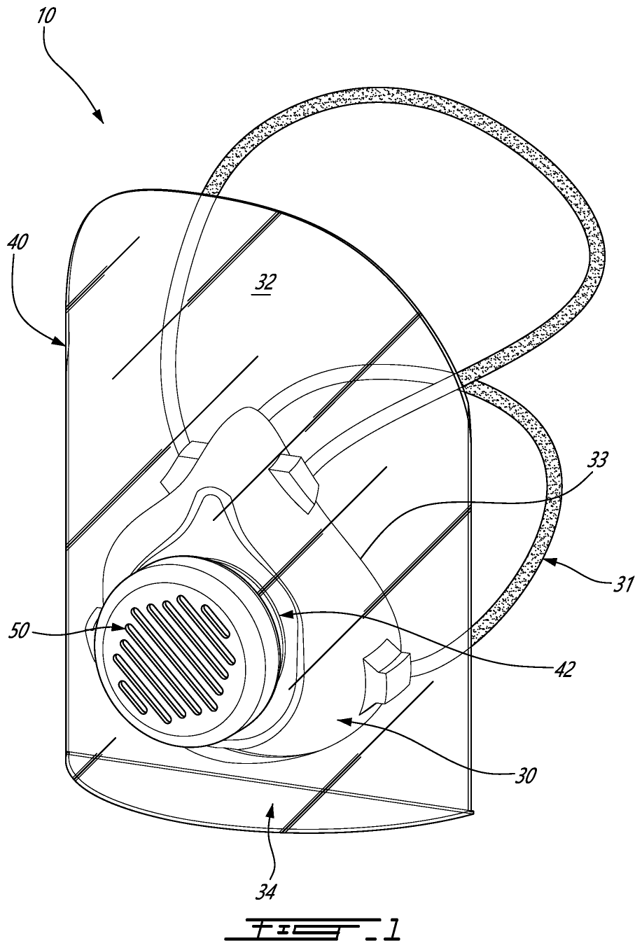

The mask 30 is configured to be air-tightly secured in contact with the face of the wearer, maintained about the head of the wearer by straps 31 for example, as described hereinbelow and illustrated for example in FIGS. 1,2, 8 and 10. The face shield 40 is air-tightly connected to a passageway of the mask.

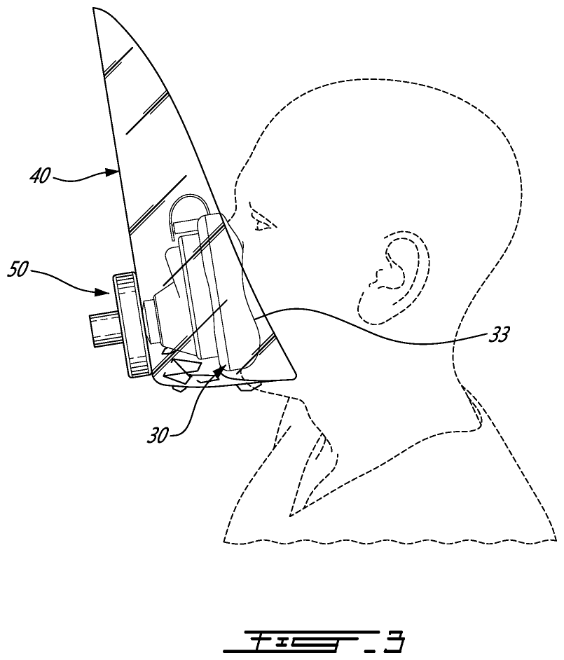

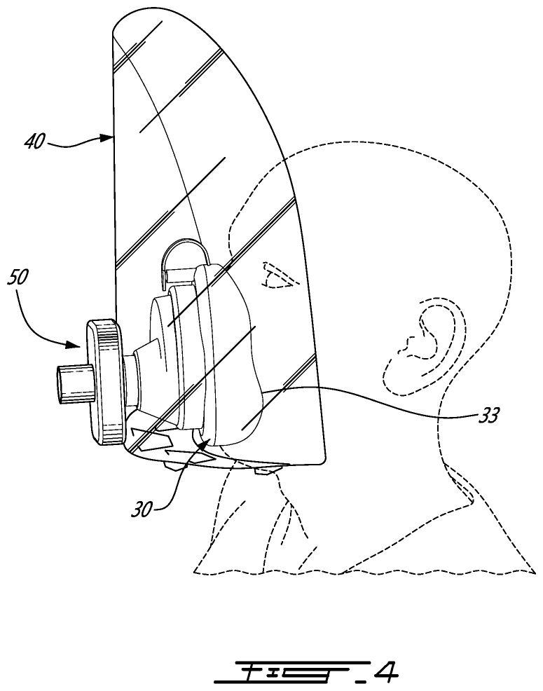

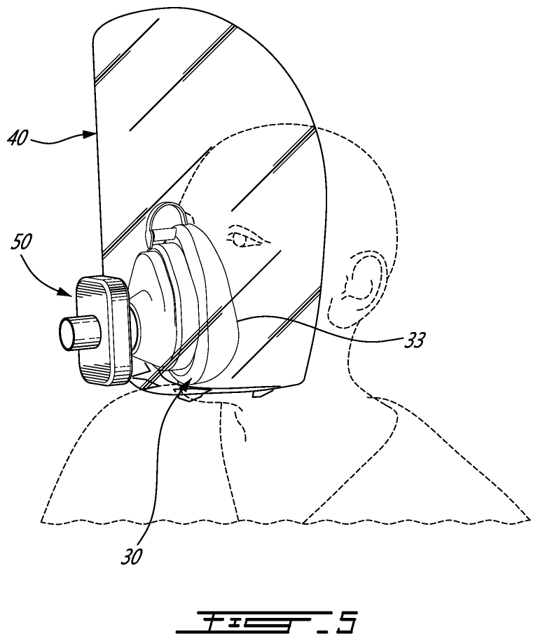

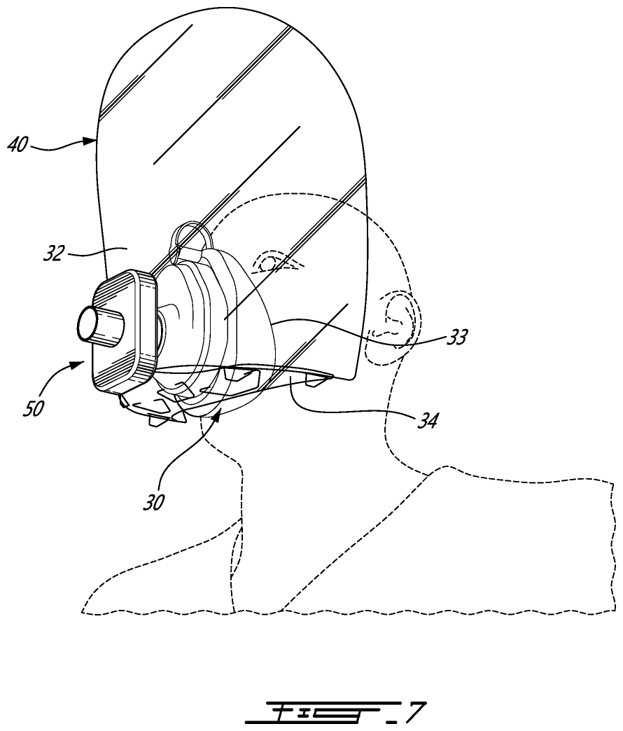

The mask as best seen for example in FIGS. 3-7 comprises a circumferential edge surface 33 in airtight contact with the skin of the wearer and air-tightly enclosing the mouth and the nose of the wearer.

The mask extends from the circumferential edge surface 33 to a front surface at a distance from the face of the wearer when the mask is worn.

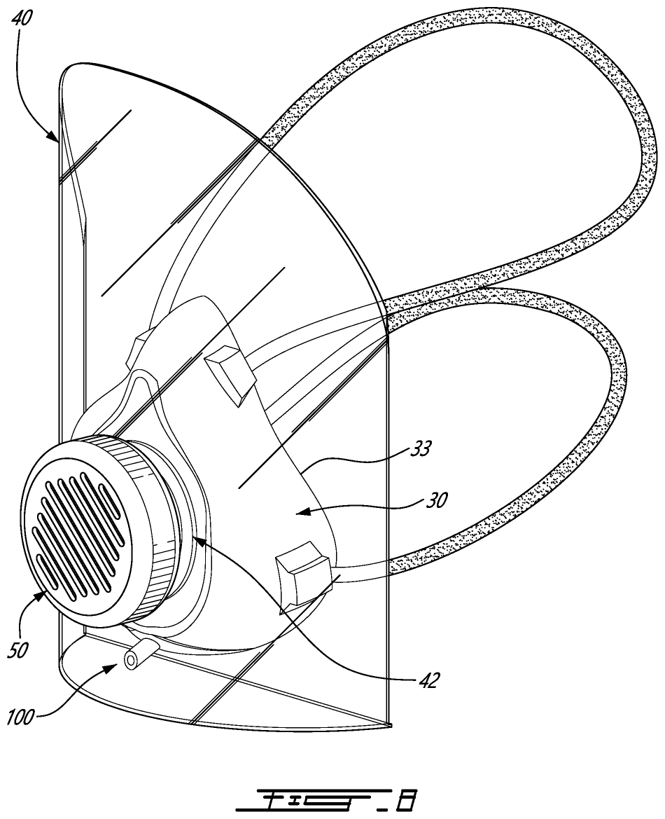

In an embodiment illustrated for example in FIG. 8, the mask 30 comprises a port tube 100 for use during portacount respirator fit tests for example.

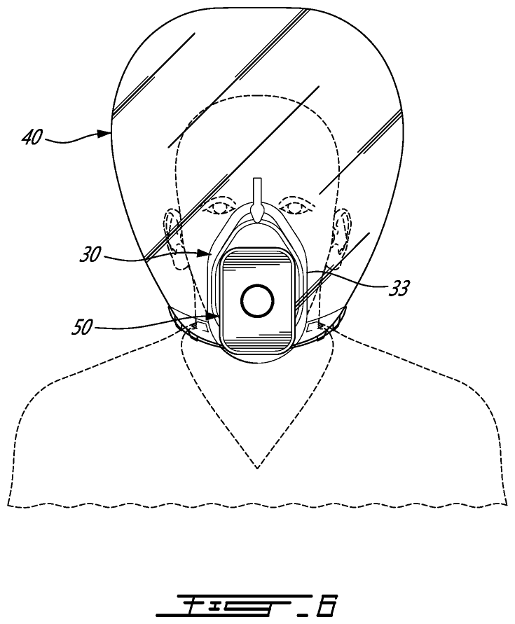

According to an embodiment of an aspect of the present disclosure, the face shield 40 comprises a front surface 32 and a bottom surface 34 extending backwards from the front surface 32 as seen in FIGS. 3-7 for example. The front surface 32 is a curved surface having lateral backwards curved sides, in such a way that, in combination the front surface 32 and the bottom surface 34 encase the wearers face, below and on each side of and the wearers face. The front surface 32 as illustrated in FIG. 6 further has a flared geometry from its bottom edge up to its top edge.

When in place about the wearers face, the face shield 40 thus provides a mechanical barrier against aerial bacteria between the environment and the face of the wearer, from under the chin, as provided by the bottom surface 34, and both lateral sides of the wearers face well up over the nose typically from under the chin of the wearer, up to above the top of the wearer's head, as provided by the backwards lateral sides of the front surface 32. Thus efficiently shielding the wearers face from aerial projections, such as aerial bacteria and air born pathogens from under the chin as well as from both lateral sides of the face well up over the nose.

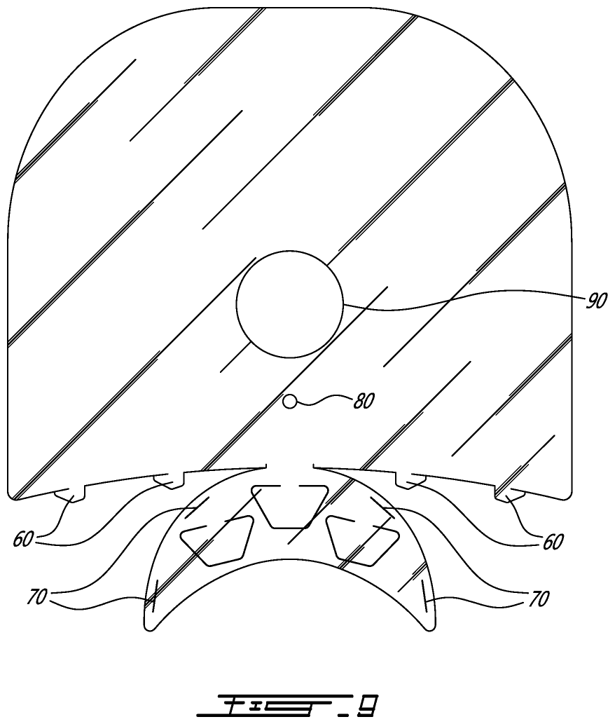

The face shield may be laser cut or water jet cut for example. In an embodiment of an aspect of the present disclosure, the face shield is die cut in a polycarbonate sheet of a thickness selected between about 0.005″ and about 0.010″ as illustrated in FIG. 9 for example. An opening 80 is provided for a port tube as discussed hereinabove in relation to FIG. 8. Stacks of sheets thus pre-cut according to target face shields shapes may be shipped in sealed packages. The cut sheets may then be folded into face shields using tabs 60/openings 70 combinations as illustrated in FIG. 9 for example.

Both inhaled and exhaled air are channelled by the face shield and the mask.

The mask may be made in silicon for example. The face shield is made in a transparent material. The materials may be adapted for sterilization such as bleach sterilization, pasteurization or hydrogen peroxide gas plasma (HPGP) sterilization such as Sterrad® for example.

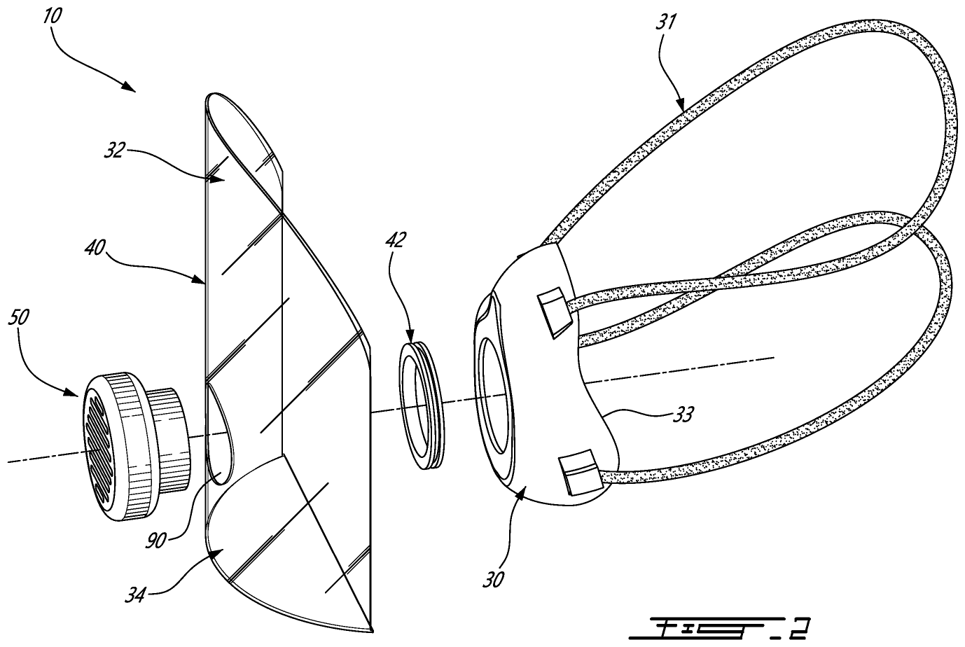

A cartridge 50 may be connected to the passageway of the front surface of the mask through an opening 90 of the face shield, by a ring 42 for example, at a distance from the face of the wearer wearing the mask, as illustrated in FIGS. 2-8. Air-tight connection between the cartridge and the passageway of the mask may be provided using a grommet, or a sealing joint of a shape selected according to the shape of the channel between the mask and the cartridge, by snapping or screwing or press-fitting for example, allowing the cartridge to be readily detachable from the equipment. A filtration cartridge may be selected according to a target protection, such as a respiratory cartridge for example. A cartridge containing a removable, disposable pad or pre-filter may be selected; so that the cartridge may be sterilised, by autoclave sterilization for example, for reuse with new pads, used pads being disposable. The pad may be a commercially available pre-cut N95 or custom design pad of a composition and structure selected according to the target protection and use of the equipment.

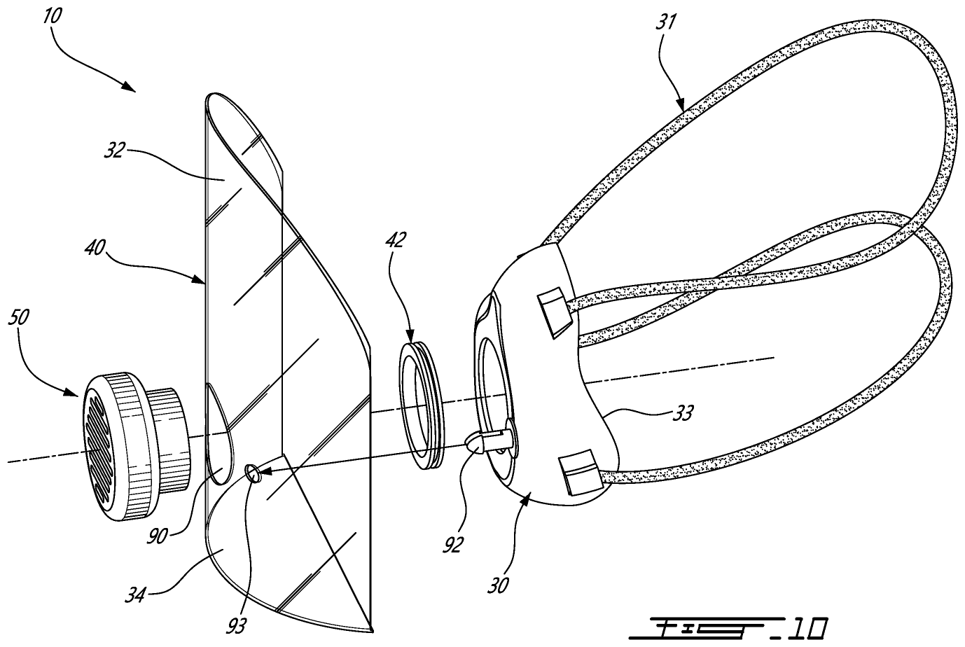

Once mounted together as a unit by the ring 42 and a fastener 92/93 as illustrated for example in FIG. 10, the mask, the face shield and the filtration cartridge are air-tightly connected to form a continuous channel for inhaled and exhaled air flow between the face of the wearer and the outside environment, from the mask air-tightly positioned around the mouth and noise of the wearer to the outside environment, through the cartridge. A channel of a diameter of at least ¼ inch, for example of about of 2 inches, is selected to allow sound propagation for communication purposes. Both inhaled and exhaled air being channelled through the cartridge, the unit is a bidirectional respiratory equipment, providing protection both to the wearer and to people in the wearers surroundings.

Positioned between the mask 30 and the cartridge 50, the face shield is protected from fog generated by air inhaled and exhaled through the cartridge and due to the wearers breathing. Moreover, the face shield being distanced from the face of the wearer by the mask, the face shield does not interfere with glasses worn by the wearer.

The cartridge, mask and face shield may be sterilized by bleach sterilization, pasteurization or Sterrad® for example. Straps may be made in a material adapted for sterilization by autoclave sterilisation for example, and reuse, such as silicon for example. All part of the present unit are readily manually detached and removable for sterilisation purpose.

The present wearable is a removable mechanical barrier preventing environment air from accessing the nose and mouth from under the chin, from both lateral sides of the head, and from above the nose of the wearer. When air-tightly connected with a cartridge the wearable provides a barrier against aerial bacteria and pathogens.

The scope of the claims should not be limited by the embodiments set forth in the examples, but should be given the broadest interpretation consistent with the description as a whole.

1. A wearable personal protection, comprising a mask configured to be air-tightly secured in contact with the face of a wearer and a face shield configured to be air-tightly connected to a passageway of the mask.

2. The wearable unit of claim 1, wherein the face shield comprises a front surface and a bottom surface extending at an angle from said front surface.

3. The wearable unit of claim 1, wherein the face shield comprises a front surface having backwardly curved lateral sides and a bottom surface extending at an angle from the front surface.

4. The wearable unit of claim 1, wherein the face shield comprises a front surface having a flared geometry from a bottom edge thereof up to a top edge thereof, and a bottom surface extending at an angle from the front surface.

5. The wearable unit of claim 1, wherein the face shield comprises a front surface having a flared geometry from a bottom edge thereof up to a top edge thereof and having backwardly curved lateral sides, and a bottom surface extending backward from the front surface.

6. The wearable unit of claim 1, wherein a circumferential edge surface of the mask encloses the mouth and the nose of the wearer.

7. The wearable unit of claim 1, wherein a cartridge-connecting ring is air-tightly mounted to the mask.

8. The wearable unit of claim 1, wherein a ring is air-tightly mounted to the mask and air-tightly connects the mask with a cartridge.

9. The wearable unit of claim 1, wherein a cartridge-connecting ring is air-tightly mounted to the mask and at least one of the ring and the mask comprises a test port.

10. The wearable unit of claim 1, wherein a cartridge-connecting ring is air-tightly mounted to the mask and the cartridge is connected with the mask by one of snapping, screwing and press-fitting.

11. The wearable unit of claim 1, wherein a cartridge-connecting ring is air-tightly mounted to the mask and the ring and the mask are dismountable for sterilisation purpose.

12. The wearable unit of claim 1, further comprising a filtration cartridge air-tightly connected to the passageway of the mask.

13. The wearable unit of claim 1, further comprising a filtration cartridge air-tightly connected to the passageway of the mask, and the face shield is air-tightly connected between the mask and the cartridge.

14. The wearable unit of claim 1, further comprising a filtration cartridge air-tightly connected to the passageway of the mask, the face shield and the filtration cartridge both air-tightly connected to the passageway of the mask providing an air-tight channel between the face of the wearer and an outside environment.

15. The wearable unit of claim 1, further comprising a filtration cartridge air-tightly connected to the passageway of the mask, the face shield and the filtration cartridge both air-tightly connected to the passageway of the mask providing an air-tight channel of a diameter of at least ¾ inch between the face of the wearer and an outside environment.

16. The wearable unit of claim 1, further comprising a filtration cartridge air-tightly connected to the passageway of the mask, the face shield and the filtration cartridge both air-tightly connected to the passageway of the mask providing an air-tight channel of a diameter of 2 inches between the face of the wearer and an outside environment.

17. The wearable unit of claim 1, wherein the mask is in silicon.

18. The wearable unit of claim 1, wherein the face shield is made in a transparent material.

19. The wearable unit of claim 1, wherein the face shield is made in a sheet of transparent material of a thickness in a range between 0.005″ and 0.010″.

20. The wearable unit of claim 1, wherein the face shield is in polycarbonate.
